(19) United States
(12) Patent Application Publication
(10) Pub. No.: US 2006/0252871 A1
(43) Pub. Date: Nov. 9, 2006

(54) PROCESS FOR INCREASING THE EXFOLIATION AND DISPERSION OF NANOPARTICLES INTO POLYMERIC MATRICES USING SUPERCRITICAL CARBON DIOXIDE

(76) Inventors: Donald G. Baird, Blacksburg, VA (US); Quang Nguyen, Fairfax, VA (US); Matthew Wilding, Christiansburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/381,554

(22) Filed: May 4, 2006

Related U.S. Application Data
(60) Provisional application No. 60/677,365, filed on May 4, 2005.

(51) Int. Cl. C08K 9/04

(52) U.S. Cl. 524/445

(57) ABSTRACT

Polymer nanocomposites are produced using a supercritical fluid (e.g., supercritical carbon dioxide). The carbon dioxide mixes with the nano-clay particulates and diffuses into the galleries to make the particulates susceptible to separation. The particulates can be subjected to a mechanical beating operation to reduce them in size and to reduce the formation of agglomerates. The particulates and supercritical fluid are then injected as a mixture directly into a polymer stream. Because the line leading to the polymer stream is open, the pressure drop as the particles travel to the polymer causes the particles to exfoliate. Further, because the supercritical carbon dioxide is present with the particles during exfoliation and injection into the polymer, the particles tend to stay exfoliated and disperse as fine particles throughout the polymer. The supercritical carbon dioxide also lowers the viscosity of the polymer to assist in distributing the exfoliated particles.

This invention was made using the supporting grants of the National Science Foundation, grant CTS-0507995, and the Environmental Protection Agency, STAR grant #R-8295501-0, and the U.S. government may have certain rights in this invention.

### BACKGROUND OF THE INVENTION

1. Field of the Invention

The present invention generally relates to a process for creating polymeric matrices with dispersed nanoparticles therein and, more particularly, to a process and system whereby supercritical carbon dioxide is employed to exfoliate clays, such as silicates, and to assist in combining the clays with polymer matrices as fine dispersions at selected loadings.

2. Background Description

It is known that polymers reinforced with nanometer sized platelets or particles of layered silicates or clay can provide significant improvements in mechanical properties of polymer systems at much lower loadings than conventional fillers. Polymer composites reinforced in this manner are often referred to as “nanocomposites”, and typical examples would include layered silicate, e.g., montmorillonite clay, dispersed in a thermoplastic or a thermoset matrix. Nanocomposites which utilize silicates or clays have improved mechanical properties due to the high aspect ratio and surface area of the particles.

The most common methods used to synthesize nanocomposites or “nanoclays” include intercalation of a suitable monomer with subsequent in situ polymerization, intercalation of a polymer from solution into the clay, and polymer melt intercalation. Prior methodologies have been generally unsuccessful in achieving loading levels of greater than 4 wt %. Nano-clay particle levels on the order of 10 wt % could lead to a modulus increase on the order of a factor of 5 or more, as opposed to a factor of 1.5 to 2 which would result at loadings of 4 wt %.

Manke et al., in U.S. Pat. No. 6,469,073 which is herein incorporated by reference, developed a system and method of delaminating layered silicate material by supercritical fluid treatment of the silicate. In operation, the layered silicate particles are combined with supercritical fuid (CO₂). Then, through a catastrophic depressurization (e.g., immediate depressurization to ambient pressure), the layered silicate particles will essentially burst apart or “exfoliate” to form, for example, individual layers of silicate which can be better combined with a polymer matrix due to the greater exposed surface area. In its natural state, clay is made up of stacks of individual particles held together by ionic forces. The clay is generally hydrophilic, while the polymer it is to be combined with is generally hydrophobic. Thus, clays and polymers are generally incompatible. The Manke process basically divides the individual layers by having the supercritical fluid intercalate between the layers due to its low viscosity and high diffusivity, and then, upon depressurization, the interstitial supercritical fluid forces the particles to “exfoliate” or “delaminate” from each other. Manke suggests that a reinforced polymer, having between as low as 0.1 and as high as 40% by weight montmorillonite clay, could be made by adding the exfoliated particles to the polymer (e.g., polypropylene) in conventional mixer, extruder or injection molding machine. However, Manke does not provide any mechanism for assuring that the exfoliated particles remain exfoliated when they are combined with the polymer, and does not provide a superior mechanism for dispersing the particles of silicates within the polymer matrices.

Mielewski et al, in U.S. Pat. No. 6,753,360 which is herein incorporated by reference, describes the preparation of reinforced polymers having improved mechanical properties. Mielewski contemplates first combining the layered silicates with the polymer, and then treating the mixture of silicate and polymer with a supercritical fluid. Similar to Manke (discussed above-Manke being a co-inventor on Mielewski), Mielewski contemplates a depressurization step to exfoliate the mixture of layered silicates and polymer after supercritical fluid has been allowed to diffuse through the polymer and clay and to intercolate between the layers. The rapid depressurization causes the layers of silicate to split apart and disperse themselves within the polymer matrix. Mielewski takes advantage of the supercritical fluid reducing the melt viscosity of the polymer, but does not provide very good control over the size of the particles obtained and does not appear to effectively address adverse effects of the depressurization such as foaming of the polymer.

### SUMMARY OF THE INVENTION

It is an exemplary embodiment of the invention to provide a system and method which employs supercritical fluids for producing polymer composite materials with a high level of exfoliated nano-clays or other nanocomposites that have improved mechanical, barrier, and electrical properties.

It is another exemplary embodiment of the invention to provide a system and method which employs supercritical fluids for precisely controlling the dispersion of clay particulates in polymer matrices in terms of the size of particulates, the weight percentage of the particulates, and the degree of uniformity of the dispersion produced.

According to the invention, supercritical fluids, such as supercritical CO₂ are combined under pressure, preferably with the application of heat, with clay particulates such as silicates. The mixture of clay particulates and supercritical fluid is permitted to sit, mix or coalesce for a period of time sufficient to allow the supercritical fluid to intercolate within the layers of the clay particulates. The mixture is then added, while under pressure, to a polymer melt, such as in an extruder, mixer or other processing machinery. Addition of the mixture to the polymer melt is preferably done by a process or apparatus which precisely meters the clay particulates so that both the size of the particulates and the amount of particulate can be regulated to achieve precise loading and more uniform dispersion of similarly sized particulates. In one embodiment, this is accomplished using a metering chamber which regulates the flow of supercritical fluid so as to transport only particulates of a certain size to an extruder. In addition, a screen or other sizing mechanism can be employed to eliminate aggregates from being added to the polymer. After addition, the polymer/clay/supercritical fluid mixture may be subjected to a spinning process or be added to a second extruder which allows the supercritical fluid to be diffused from the polymer in a controlled fashion, preferably without foaming.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic of an exemplary supercritical CO₂ injection system with a step down chamber and fiber bundle spinning;

FIG. 2 is a schematic of an exemplary mixing and absorption chamber for combining supercritical fluid with clay particulates, mixing the particulates so as to allow intercalation or diffusion of the supercritical fluid within the clay particulates, and controllably supplying particulates of a particular size to the polymeric mixture;

FIG. 3 is a table showing tensile properties of various nanocomposites;

FIG. 4 is a bar graph showing the Young's modulus of PaxonAM55/Cloisite 15A nanocomposites;

FIG. 5 is a bar graph showing the Young's modulus of HHM-5502/Cloisite 15A nanocomposites; and

FIG. 6 is a graph showing the x-ray diffraction results on various nanocomposites.

### DETAILED DESCRIPTION OF THE PREFERRED EMBODIMENTS OF THE INVENTION

In the practice of the invention, supercritical fluids (SCFs) are combined with clays and with polymeric materials to produce composites with improved mechanical properties with the polymeric materials being reinforced by dispersed clay particulates. A variety of supercritical fluids could be used in the practice of this invention including supercritical carbon dioxide (CO₂), supercritical alkanes (hydrocarbons), supercrictical fluorocarbons, water, ammonia, noble gases, and sulfur hexafluoride (SF₆). Supercritical CO₂ is preferred as it has been widely used in many applications, it is environmentally friendly, nontoxic, nonflammable, functions as a reversible plasticizer, and is relatively low cost. The principal requirement is that fluid be in a supercritical state, and preferably that it diffuse within the clays and polymers used in the practice of this invention, and preferably decrease the viscosity of the polymers. The clays can be a variety of different materials such as silicates (e.g., montmorillonite). Preferably, the clays will be of a submicron or nanometer size, and may contain alkalis such as aluminum, lithium, magnesium, and iron between particulate sheets. Almost any polymer or mixture of polymers can be used for the polymeric matrix. Examples include but are not limited to polyethylene (e.g., high density polyethylene (HDPE), polypropylene (PP), polyethyelene terephthalate (PET), and polyacrylonitriles (PAN).

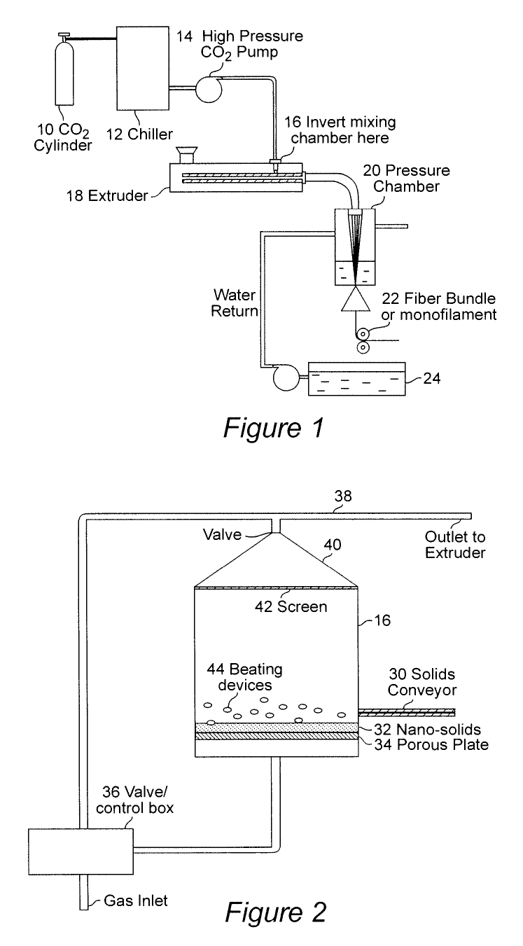

Referring to FIG. 1, it can be seen that carbon dioxide from a source such as cylinder 10 is chilled in a chiller 12 and passed through a high pressure pump 14 to create supercritical carbon dioxide. The supercritical carbon dioxide is combined with clay at a chamber 16, described in more detail in FIG. 2 (FIG. 1 shows the insertion site for chamber 16 as an arrow), and the combined clay and supercritical carbon dioxide mixture is added to polymer material such as a molten polymer stream or mixture of polymers in an extruder 18. Preferably, the combined product will be extruded into a pressurized chamber 20 so as to keep the carbon dioxide dissolved in the polymer and to prevent foaming. In the exemplary embodiment of FIG. 1, the process can be part of a continuous spinning process where fiber bundles or a monofilament of polymer matrix with dispersed clay particulates therein are pulled from the chamber 20 using rollers 22. A water bath 24, similar to that used for manufacturing PAN materials, can be used for assisting in the fiber pulling operation. The carbon dioxide diffused within the polymer can be allowed to diffuse slowly from the forming and formed fiber bundle. Alternatively, the diffused carbon dioxide might also be removed by feeding the mixture from extruder 18 into another extruder (not shown) which is designed for devolitilization. Also, as an alternative, the feed from the extruder 18 can be sent to a closed pressurized chamber where the composite material is cooled below its glass transition temperature to prevent foaming. Other treatment methodologies can also be employed. After diffusion of the carbon dioxide out of the polymer and clay fiber or molding, the materials can be ground and pelletized for further processing.

In FIG. 1, the supercritical carbon dioxide will help in the dispersion of the particulate in the polymer or polymer mixture by keeping the particulates exfoliated during the mixing, and possibly by helping the mixing and distribution by carrying the nano-clays into the free volume regions of the polymer. Furthermore, the supercritical carbon dioxide should lower the viscosity of the melt through its ability to plasticize the polymer. This would also help the polymer to penetrate the galleries (areas between particles).

FIG. 2 shows an exemplary system for metering in a mixture of nano-clay and carbon dioxide into the polymer material. While system is shown as a batch process, the system and method of the invention can be modified to be continuous in operation. Specifically, the chamber 16 could have a conveyor 30 for conveying nano-solids 32 therein. The nano-solids 32 would be positioned on porous plate 34. The nano-solids will include clay materials, but also can include other fillers to be added to the polymer matrix. The porous plate 34 will function to distribute the flow of supercritical fluid (e.g., carbon dioxide) through the bed of nano-solids 34. As discussed in conjunction with FIG. 1, high pressure supercritical carbon dioxide is generated by a high pressure pump. The supercritical carbon dioxide is directed through a valve or control box 36 which can selectively allow the supercritical carbon dioxide to bypass the chamber 16, or to enter the chamber 16 under the porous plate 34. The valve or control box 36 can be used to selectively adjust the flow of high pressure supercritical carbon dioxide to the chamber 16 by diverting greater or lesser amounts of carbon dioxide to the chamber. Similarly, control of the pump (shown in FIG. 1) can also be a mechanism for controlling the flow rate.

The top of the chamber 16 is open to the line 38 which attaches to the extruder (shown in FIG. 1) or other polymer processing device (e.g., mixer, etc.). Because the line 38 is open, the supercritical carbon dioxide will continuously pass through the chamber causing the particles (nano-solids 34) to rise and fall. Furthermore, the open line 38 allows a pressure drop which causes the nano-solids to exfoliate (as is discussed in U.S. Pat. No. 6,469,073 to Manke) both in the chamber 16 and in the line 38. Preferably the pressure is allowed to drop rapidly to the critical pressure (approximately 1000 psi; e.g., a 3000 to 1000 psi drop in approximately 5 seconds or less). The residence time of the nano-solids 34 in the chamber 16 will be controlled by the ratio of flows or pressures of the supercritical carbon dioxide above and below. The residence time will depend on the time required for supercritical carbon dioxide to diffuse into the galleries and the pressure (solubility). The mixture of supercritical carbon dioxide and nano-solids 34 will pass through a duct 40 before entering the extruder containing porous media (e.g., screen 42) with various pore sizes for the purpose of disrupting any aggregates and to further promote mixing of the nano clay and carbon dioxide. The concentration of the clay will be adjusted by the flow rate of the mixture of nano-solids and carbon dioxide relative to the flow rate of the polymer melt in the extruder. Preferably, when a two stage single screw extruder is employed, as shown in FIG. 1, the screw channel is designed with deep flights so the pressure drops at the entry point permit the flow of gas. Various amounts will be injected to vary the level of nanoclay particles.

The chamber 16 could be operated so as to have the ability to separate the particles by size by adjusting the gas velocity. For example, a low velocity gas will carry on the smallest nano-solids 34, which should be the exfoliated particles. As the gas velocity is increased, then larger particles will be carried into the extruder and mixed with the polymer melt.

Inside chamber 16 are a series of “beating devices” 44. These devices 44 can be associated with a roller which brushes against the nano-solids 34, or can be a plurality of large metal particles (e.g., ball bearings) which rise and fall with gas pressure, or can be any other form of mechanical device which is used to agitate, stir, or impact with the nano-solid particulate while it is in the chamber 16. As the carbon dioxide diffuses into the clay materials, the layers of the nano-clays are more susceptible to separation by simple mechanical operations. This helps produce exfoliated particles which rise to the top of the chamber 16 based on the flow of supercritical carbon dioxide as discussed above. The exfoliated particles, which will be the smallest and lightest particles, will be transported to the extruder and combined with the polymer melt. Because supercritical carbon dioxide is mixed with the exfoliated particles, the particles tend to remain exfoliated when combined with the polymer. Further, the supercritical carbon dioxide mixes with the polymer melt, and diffuses therein, and functions to assist in carrying in and dispersing the particles within the polymer. Thus, when the polymer matrix is solidified, it is filled with clay nanoparticles. The loading can vary depending on the needs of the product, and may be as little as 0.1% by weight or as high as 50% by weight.

### EXAMPLE 1

This is Example is similar to the techniques discussed in U.S. Pat. No. 6,753,360 to Mielewski where nano-clays are combined with polymer and melt blended. Subsequently, supercritical carbon dioxide was injected. This procedure provides some benefits, but not nearly as much as is provided by the process set forth in Example 2 where the supercritical carbon dioxide directly contacts the nano-clay, absorbs into the galleries, and the pressure is then released rapidly (drop from 3000 psi to 1000 psi in 5 seconds or less), the clay is separated and exploded, and then the misutre is injected into the extruder where it is mixed with the polymer melt.

Materials. High-density polyethylene (HDPE) HHM-5502 resin with Mw=45,000 g/mol and Mw/Mn=3.0 and HDPE PaxonAM55-003 resin were provided from Chevron Phillips Chemical Company and P&G, respectively, and were used as received. Surface modified montmorillonite (Cloisite 15A) was obtained from Southern Clay Products, Inc. Cloisite 15A and 20A are obtained from a surface modified montmorillonite through a cation exchange reaction, where the sodium cation is replaced by dimethyl, dihydrogenated tallow, quaternary ammonium cation.

Extrusion Experiments. The concentration of Cloisite 15A for the two HDPE/15A systems, HHM-5502/15A and PaxonAM55/15A, were approximately 4 wt %. Due to a certain percentage of surfactant in 15A, the net amount of clay is actually <4 wt %. HDPE/15A nanocomposite strands were prepared via direct melt compounding using a single screw Killion KL-100 extruder with a 25.4 mm (1 inch) diameter 30:1 L/D two-stage screw. An Omega model FMX8461 S static mixer was used for enhanced mixing between the extruder and screw. An injection port at the beginning of the second stage of the screw was used for injection of CO₂. The CO₂ was pressurized with a Trexel model TR-1-5000L supercritical fluid unit. CO₂ flow was measured using a MicroMotion Elite CMF010P Coriolis mass flow meter and an RFT9739 transmitter.

Rheological Studies. Rheological studies of the nanocomposites were performed using a Rheometrics Mechanical Spectrometer Model 800 (RMS-800). Samples are prepared by injection molding of the extruded pellets into 1.6 mm thick plaques and then cut into 25 mm diameter disks. Dynamic frequency sweep experiments were performed using 25-mm parallel-plate fixture at 190° C. in the linear viscoelastic region of the materials. To determine the limits of linear viscoelastic properties of the materials, dynamic strain sweeps were performed at 190° C. and a frequency of 10 rad/s. From the results, it was determined that it can be safe to perform dynamic frequency sweep experiments at a fixed strain of 5%, which is well within the linear viscoelastic range of the materials investigated. The gap was set at 1.4 mm. The elastic moduli (G′), loss moduli (G″), and complex viscosities (η*) of the materials as functions of angular frequency (ω) (ranging from 0.04 to 100 rad/s) are obtained.

Mechanical Properties. The produced extrudates were pelletized and then injection molded into plaques using an Arburg Allrounder Model 221-55-250 molding unit. The plaques were cut into rectangular bars along the machine direction. Tensile tests on these bars were performed at room temperature using an Instron model 4204 testing machine. An extensometer was used to accurately determine Young's modulus and yield strength.

Wide Angle X-Ray Diffraction. WAXD patterns were conducted using a Scintag XDS 2000 diffractometer with CuKalpha radiation (wavelength=1.542A) at a scan rate of 0.5 deg/min.

Results

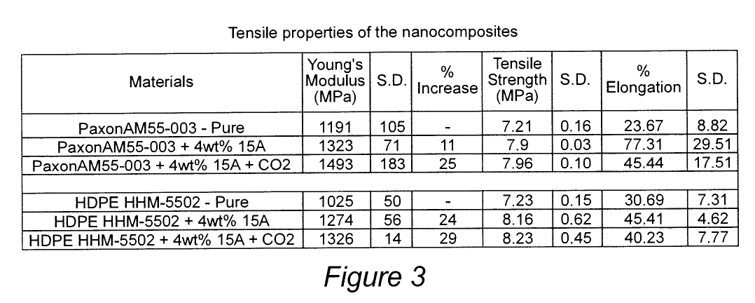

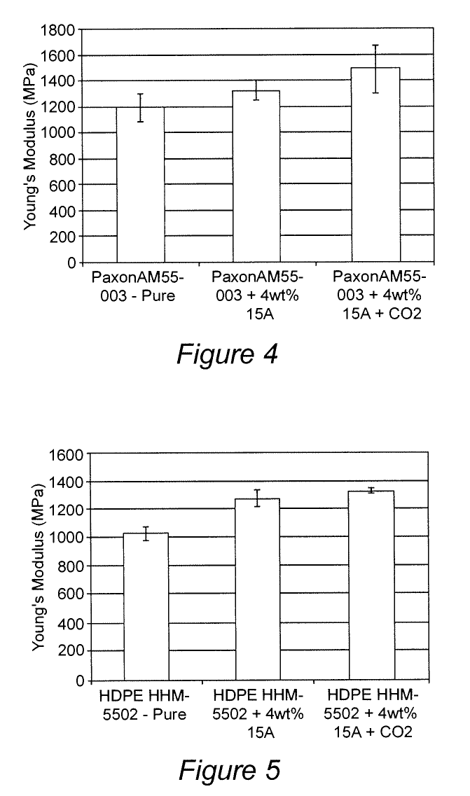

The mechanical properties of the two HDPE nanocomposite systems, namely HHM-5502/15A and PaxonAM55/15A, processed with and without CO₂ are summarized in FIGS. 3-5. It can be seen from the table in FIG. 3 that pure PaxonAM55 has a Young's modulus of 1191±105 MPa. With the addition of approximately 4 wt % Cloisite 15A, PaxonAm55/15A nanocomposite was found to have a Young's modulus of 1323±71 MPa, an increase of about 11% compared to that of pure PaxonAM55. The tensile strength also increased from 7.2 to 7.9 MPa. The same system prepared in the presence of sc-CO₂ was found to have a Young's modulus of 1493±183 MPa, an increase of 25% compared to that of pure PaxonAM55. Similar trends were also observed for HHM-5502/15A system. Tensile modulus of the nanocomposite prepared with sc-CO₂ is higher than that of the one prepared without sc-CO₂. This indicates an essential contribution of the presence of sc-CO₂ to the melt intercalation process, suggesting that the addition of sc-CO₂ can enhance the mixing and the degree of intercalation/exfoliation of the clay in the polymer matrix. Also, the injection molded plaques of the nanocomposites processed without CO₂ appeared to be opaque, whereas the ones prepared in the presence CO₂ appear to be a little shinier and more transparent. A higher degree of exfoliation of the clay into finer particles could be the reason why the scCO₂-treated samples appear more transparent than the non-treated samples.

The elastic moduli (G′), loss moduli (G″), and complex viscosities (η*) of pure PaxonAM55, PaxonAM55/15A nanocomposites, and PaxonAM55/15A nanocomposite prepared with sc-CO₂ were compared and showed at low frequency, PaxonAM55/15A nanocomposite melts have higher G′, G″, and η* compared with pure PaxonAM55. At higher frequency, however, the values of G′, G″, and η* converge. PaxonAM55/15A nanocomposite melts prepared with sc-CO₂ exhibit the highest G′, G″, and η* at low frequency. These rheological behaviors and mechanical properties suggest that the presence of sc-CO₂ can change the final structure and morphology of the polymer/clay nanocomposites. The addition of sc-CO₂ can also reduce the viscosity of a polymer melt, therefore, it can promote easier diffusion of polymer chains between the silicate galleries. This means that the addition of sc-CO₂ can enhance the degree of intercalation of the clay in the polymer matrix.

### EXAMPLE 2

The pressurized chamber of FIG. 2 was applied to the preparation of the polypropylene/20A nanocomposites. This chamber was inserted between the CO₂ pump and the injection port at the beginning of the second stage of the screw as shown by the arrow in FIG. 1. The clays were allowed to be in direct contact with sc CO₂ at 2500 psi and 80° C. for a period of time and then were rapidly released. The mixture of the nano-particles and sc-CO₂ were then injected into the molten polymer stream in a single screw extruder. The produced extrudates were pelletized and then injection molded into plaques using an Arburg Allrounder Model 221-55-250 molding unit for further characterization.

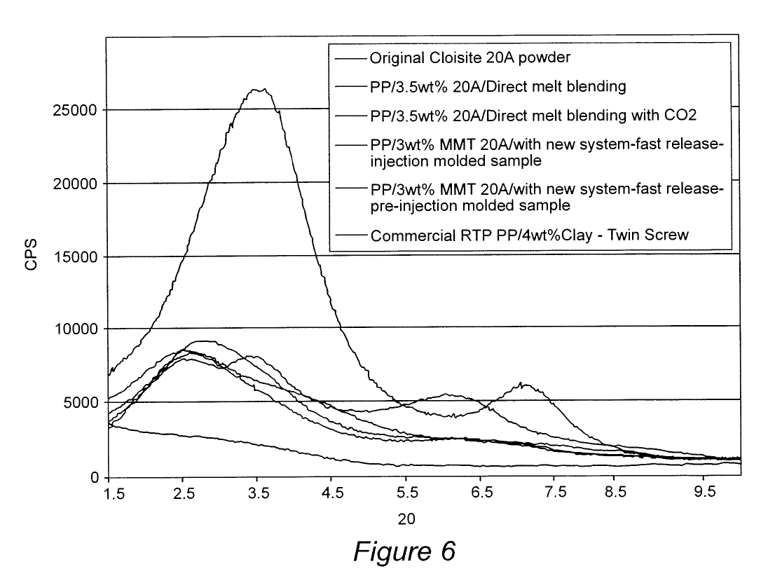

WAXD patterns for pristine organoclay 20A powder, commercial RTP PP-4 wt % clay nanocomposites, and PP6523/clay nanocomposites prepared via direct melt compounding and using the new pressurized chamber are shown in FIG. 6. The clay concentration on the composites produced via direct melt compounding is about 3.5 wt %. The average clay concentration on the composites produced using the new system is about 3 wt %. WAXD patterns for commercial RTP sample and samples prepared via direct melt blending all show peaks, but shifted to lower angles, indicating expansion of the d-spacing due to intercalation of polymer between the galleries. WAXD pattern for the composite sample prepared using the chamber before the injection molding process shows no peak, which may indicate full exfoliation of the clays. However, the peak reappears after the injection molding process, suggesting partial collapse of the clays during this process. The peak, however, is shifted to a lower angle, even lower than those of other composite samples, which indicates the most expansion of the clay galleries. This suggests that using the metering chamber is more effective in swelling and expanding, if not exfoliating, the clays and helps facilitate the intercalation of polymer into the clay galleries.

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A system for forming polymer-clay nanocomposite materials, comprising:
a chamber for combining a supercritical fluid with clay particulate material;
a polymer melt stream; and
a line connecting said chamber to said polymer melt stream, said line being positioned above said chamber, said line allowing for a sufficient reduction in pressure in said chamber and said line to cause said supercritical fluid to exfoliate said clay particulate matter, and said line allowing for the delivery of both said supercritical fluid and said clay particulate in exfoliated form to said polymer melt stream.

2. The system of claim 1 wherein said polymer melt stream is positioned in an extruder.

3. The system of claim 1 further comprising a diffuser positioned below said clay particulate for distributing said supercritical fluid through a bed of said clay particulate.

4. The system of claim 1 further comprising porous media positioned between said clay particulate and said line, said porous media permitting only of clay particulate of smaller than a specified size to pass into said line.

5. The system of claim 1 further comprising a beating device for impacting said clay particulate while it is in said chamber.

6. The system of claim 1 further comprising a source of supercritical fluid, and wherein said supercritical fluid is carbon dioxide.

7. The system of claim 1 further comprising a pressurized chamber for maintaining said supercritical fluid within a polymer melt delivered from said polymer melt stream.

8. A method of forming polymer-clay nanocomposites, comprising the steps of:
combining a supercritical fluid with clay particulates;
allowing said supercritical fluid to diffuse within said clay particulates;
exfoliating said clay particulates via a pressure release; and
delivering a mixture of said supercritical fluid and said clay particulates in exfoliated form directly into a polymer melt stream.

9. The method of claim 7 wherein step of delivering is performed by injecting said mixture into an extruder.

10. The method of claim 7 wherein said supercritical fluid is supercritical carbon dioxide.

11. The method of claim 7 wherein said clay particulates include silicates.

12. The method of claim 7 further comprising the step of mechanically beating the clay particulates during said allowing step.

13. The method of claim 7 wherein said polymer melt stream includes more than one polymer.

14. The method of claim 7 further comprising the step of maintaining said polymer melt stream under pressure sufficient to maintain the supercritical fluid in the polymer for a period of time after said delivering step.

15. The method of claim 14 further comprising the step of preparing a fiber bundle or mono filament from said polymer melt stream.

16. The method of claim 7 further comprising the step of releasing said supercritical fluid from a mixture of said polymer, said clay particulate in an exfoliated state, and said supercritical fluid.

17. The method of claim 16 where said step of releasing is performed by diffusion of said supercritical fluid.

18. The method of claim 16 further comprising pellettizing said mixture after said releasing step.
